(19) United States
(12) Patent Application Publication
(10) Pub. No.: US 2008/0094668 A1
(43) Pub. Date: Apr. 24, 2008

(54) IMAGE READING DEVICE AND IMAGE FORMING APPARATUS

(75) Inventor: Shinya Matsui, Amagasaki-shi (JP)

Correspondence Address: DITTHAVONG MORI & STEINER, P.C., 918 Prince St., Alexandria, VA, 22314, US

(73) Assignee: Kyocera Mita Corporation, Osaka (JP)

(21) Appl. No.: 11/869,103

(22) Filed: Oct. 9, 2007

(30) Foreign Application Priority Data
Oct. 19, 2006 (JP) 2006-285324

(51) Int. Cl. H04N 1/04

(52) U.S. Cl. 358/449

(57) ABSTRACT

The image reading device comprises a control unit that controls a document-size detection unit to perform the first document-size detection (S13) when a document retainer is detected to be in a predetermined position (S12) and to perform the second document-size detection (S16) when the amount of reflected light measured by a reflected-light amount measurement unit reaches a predetermined value or more (YES in S15) after the first document-size detection, and a document-size determination unit for determining the size of an original document on a document table (S17) from the sizes of the original document obtained through the first and second detections performed by the document-size detection unit.

### BACKGROUND OF THE INVENTION

1. Field of the Invention

This invention relates to an image reading device and an image forming apparatus, and in particular to an image reading device having a mechanism for detecting the size of an original document sheet placed on a document table and an image forming apparatus having such an image reading device.

2. Description of Background Art

Some image reading devices in image forming apparatuses are provided with a document-size detection mechanism to detect the size of an original document sheet placed on a document table. The following is a brief description of a general document-size detection mechanism. First, an original document, which is placed on a glass platen serving as a document table and is retained by a document retainer, is exposed to light emitted from an internal light source through the glass platen. Second, the intensity of light reflected from each position is measured to identify the position of edges of the original document on the document table, thereby detecting the size of the original document.

Japanese unexamined patent publication No. 11-125872 discloses a technique related to an image reading device with the document-size detection mechanism to accurately detect the size of an original document sheet. According to the publication, the image reading device performs the first document-size detection as a document retainer for retaining original documents is closed at a predetermined angle. Then, the second document-size detection is performed upon complete closing of the document retainer. This technique realizes accurate detection of document size even if the original document is difficult to make a contrast with the outside area of the document and therefore it is difficult to detect its size.

The image reading device having the configuration as shown in Japanese unexamined patent publication No. 11-125872 needs a switch to detect that the document retainer is closed at a predetermined angle and a switch to detect that the document retainer is completely closed. Such two switches provided in the image reading device cause an increase in cost and complication of the mechanism.

### SUMMARY OF THE INVENTION

An object of the present invention is to provide an image reading device with a low-cost configuration and capability of accurately detecting the size of an original document.

Another object of the present invention is to provide an image forming apparatus capable of readily and accurately forming images according to the size of the original document.

The image reading device according to the present invention comprises a document table on which an original document is placed, an openable and closable document retainer, a detection switch, a document-size detection unit, a reflected-light amount measurement unit, a control unit and a document-size determination unit. The document retainer retains an original document on the document table, and has a white portion on a surface that holds the original document. The detection switch detects that the document retainer is in a predetermined position. The document-size detection unit detects the size of the original document on the document table. The reflected-light amount measurement unit is placed below an area on which the original document is not placed and which faces the white portion when the document retainer is closed. The reflected-light amount measurement unit irradiates light upwardly from below the document table and measures the amount of the reflected light. The control unit controls the document-size detection unit to perform the first document-size detection when the document retainer is detected to be in a predetermined position and to perform the second document-size detection when the amount of the reflected light measured by the reflected-light amount measurement unit reaches a predetermined value or more after the first document-size detection. The document-size determination unit determines the size of the original document placed on the document table from the sizes of the original document obtained by the first and second detections performed by the document-size detection unit.

According to the present invention, when the amount of the reflected light in the area on which the original document is not placed and which faces the white portion provided on the surface for holding the original document reaches the predetermined value or more, the document retainer is recognized to be completely closed and the second document-size detection is performed. This configuration does not require a switch for detecting that the document retainer is completely closed to perform the second document-size detection. Accordingly, the size of the original document can be accurately detected with a low-cost configuration.

Preferably, the white portion of the image reading device is provided on the entire surface for holding the original document.

More preferably, in the image reading device, the document-size determination unit determines the size of the original document from the original-document size detected through the first detection after a predetermined time period even if the amount of the reflected light measured by the reflected-light amount measurement unit is less than the predetermined value.

More preferably, in the image reading device, the control unit controls the document-size detection unit to perform the second document-size detection even if the document retainer is not completely closed after the first document-size detection.

In another aspect of the present invention, an image forming apparatus comprises any one of the above-described image reading devices.

The image forming apparatus according to the present invention comprises the image reading device having a low-cost configuration and capable of accurately detecting the size of the original document. Accordingly, the image forming apparatus can readily and accurately form an image according to the size of the original document.

### BRIEF DESCRIPTION OF THE DRAWINGS

FIG. 1 is a block diagram showing the entire structure of a multifunctional device according to an embodiment of the present invention.

FIG. 2 is a schematic top view of the image reading device.

FIG. 3 is a schematic side view of the image reading device shown in FIG. 2.

FIG. 4 is a flow chart showing operations of a controller upon detecting the size of an original document.

FIG. 5 illustrates the image reading device whose document retainer is inclined at predetermined angle α.

FIG. 6 illustrates the image reading device whose document retainer is completely closed.

FIG. 7 illustrates the image reading device whose document retainer is almost completely closed.

### DESCRIPTION OF PREFERRED EMBODIMENT

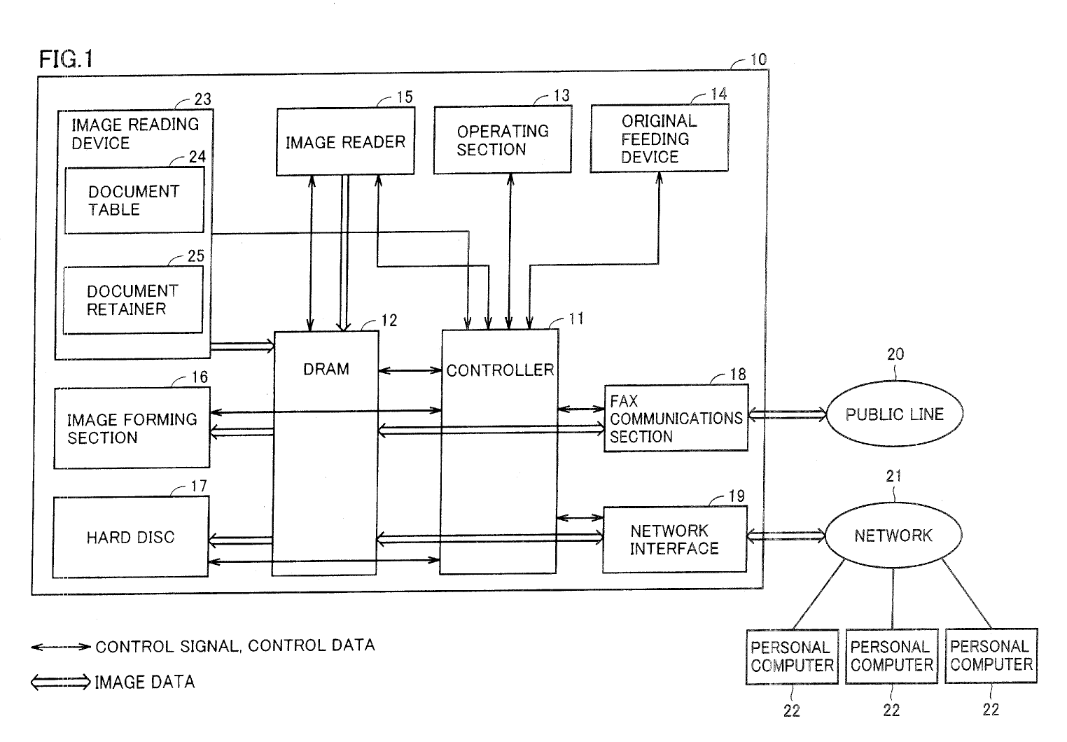

With reference to the drawings, an embodiment of the present invention will be described below. FIG. 1 is a block diagram showing a structure of a multifunctional device 10 to which an image forming apparatus according to the embodiment of the invention is applied. Referring to FIG. 1, the multifunctional device 10 comprises: a controller 11 for controlling the entire multifunctional device 10; a DRAM 12 for writing and reading image data and so on; an operating section 13 that is an interface with users of the multifunctional device 10 and includes a display to indicate information in the multifunctional device 10; an original feeding device 14 for automatically transferring an original document to a predetermined document reading position; an image reader 15 for reading images of the original document, which is transferred by the original feeding device 14, at the predetermined reading position by a scanner; an image forming section 16 for forming the images of the original document read by the image reader 15 and images obtained through other ways, a hard disk 17 for storing the image data and other data, a FAX communications section 18 connected to a public line 20, and a network IF (interface) 19 for connecting with a network 21. In addition, the multifunctional device 10 comprises an image reading device 23 for reading images of an original document placed on a document table 24.

The controller 11 compresses and encodes document data supplied from the image reader 15 and image reading device 23 to write the data in the DRAM 12, while reading out the data written in the DRAM 12, decompressing and decoding the data to output to the image forming section 16.

When the multifunctional device 10 is activated as a copying machine, the multifunctional device 10 forms an image in the image forming section 16 based on an original document which is read by the image reader 15 and image reading device 23 and sent through the DRAM 12. When the multifunctional device 10 is activated as a printer, the multifunctional device 10 forms an image in the image forming section 16 based on image data which is transmitted from personal computers 22 connected to the network 21 through the network IF 19 and the DRAM 12. Furthermore, when the multifunctional device 10 is activated as a facsimile machine, the multifunctional device 10 forms an image in the image forming section 16 based on image data transmitted from the public line 20 through the FAX communications section 18 and the DRAM 12, while transmitting original image data, which is read by the image reader 15 and image reading device 23, through the DRAM 12 and the FAX communications section 18 to the public line 20.

In FIG. 1, double-line arrows indicate flows of image data, while thin-line arrows indicate flows of control signals or control data.

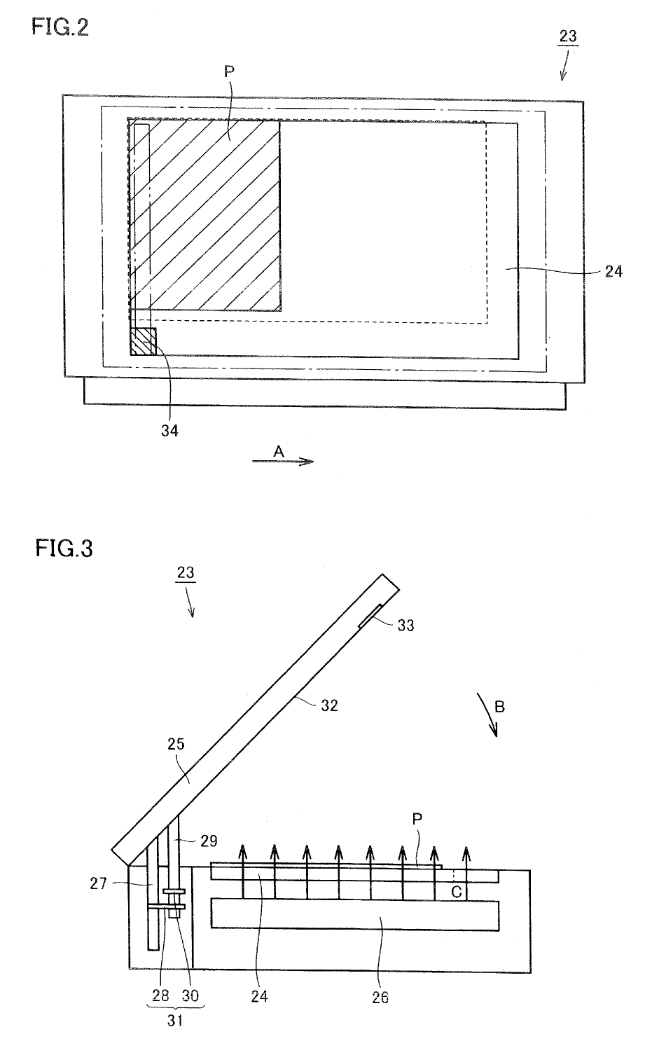

Next description will be made about a specific structure of the image reading device 23 provided in the multifunctional device 10. FIG. 2 is a schematic view of the image reading device 23 in the multifunctional device 10, when viewed from above the multifunctional device 10. FIG. 3 is a schematic view of the image reading device 23 shown in FIG. 2, when viewed from the side. FIG. 3 shows the document retainer in an open state. Referring to FIGS. 1, 2 and 3, the image reading device 23 includes a document table 24 on which original document P is placed, an openable and closable document retainer 25 for retaining the document P placed on the document table 24, and an optical unit 26 for reading images of the document P on the document table 24 and detecting the size of the document P.

The document table 24 is a transparent glass platen on which the document P can be placed. The optical unit 26 is provided below the document table 24. The optical unit 26 includes a light source shown by a dashed-dotted line in FIG. 2, a plurality of mirrors and lenses, and a CCD (Charge Coupled Device) image sensor (the mirrors, lenses, CCD are not shown in FIG. 2). The light source can move in the sub-scan direction, in other words, in the direction shown by arrow A in FIG. 2 and the inverse direction thereof.

Now, a brief description will be made about a method for reading images of the document P by the optical unit 26. The light source irradiates light toward the document table 24 in the direction of arrow C, while being moved in the sub-scan direction. The irradiated light is reflected off the document P. The reflected light is focused by the plurality of mirrors and lenses. Reading the focused light by the CCD image sensor completes reading of image data of the document P. The optical unit 26 now operates as an image reading unit. The optical unit 26 is also applied to detect white or black by calculating gradation of image data of the read image.

Next, a brief description will be made about a method for detecting the size of the document P placed on the document table 24 by the optical unit 26. As with the above-described method for reading out images, the light source irradiates light toward the document table 24 while being moved in the sub-scan direction. Subsequently, an amount of the reflected light at each position on the document table 24 is measured. The edges of the document P are identified from the measured reflected-light amount, resulting in detection of the document P size. The optical unit 26 now operates as a document-size detection unit.

The image of the original document that is readable by the optical unit 26 and the detectable document size should be in a range enclosed by a dotted line in FIG. 2. This range has an area larger than A3-size in the standard A/B-series or legal-size in the inch system. In short, general documents can be placed within the range enclosed by the dotted line.

The document retainer 25 is attached at a rear part of the document table 24 with a supporting portion 27. The document retainer 25 can move up and down, in other words, in the direction of arrow B in FIG. 3 and vice versa, in order to open and close the front part of the document retainer 25. The area enclosed by a dashed-dotted line in FIG. 2 represents the position of the document retainer 25 in a completely closed state.

The document retainer 25 is provided with a moving portion 29 that moves up and down with the upward and downward movement of the document retainer 25. The moving portion 29 has a projecting portion 30, which extends in a direction perpendicular to the moving direction of the moving portion 29, at a predetermined position thereof. The supporting portion 27 has a PI (Photo Interrupter) sensor 28 at a predetermined position thereof. The PI sensor 28 can detect the projecting portion 30 passing therethrough. The projecting portion 30 and PI sensor 28 are placed inside the image reading device 23.

The projecting portion 30 moves up and down with the up-down movement of the document retainer 25. Then, the PI sensor 28 detects the projecting portion 30 having passed the PI sensor 28. This makes it possible to detect that the document retainer 25 is in a predetermined position, that is, the document retainer 25 forms a predetermined angle with the document table 24. The projecting portion 30 and PI sensor 28 now operate as a detection switch 31 for detecting that the document retainer 25 is in a predetermined position.

As the document P is pressed by the document retainer 25, the document P faces a document-holding surface 32 having a white portion 33. The white portion 33 is positioned so as to face an area 34 on the document table 24 when the document retainer 25 is closed. The area 34 is positioned where original documents are not placed within the document table 24. The white portion 33 can reflect a lot of light from the optical unit 26. While the document retainer 25 is completely closed, the amount of light, from the optical unit 26, reflected by the white portion 33 reaches a predetermined value or more.

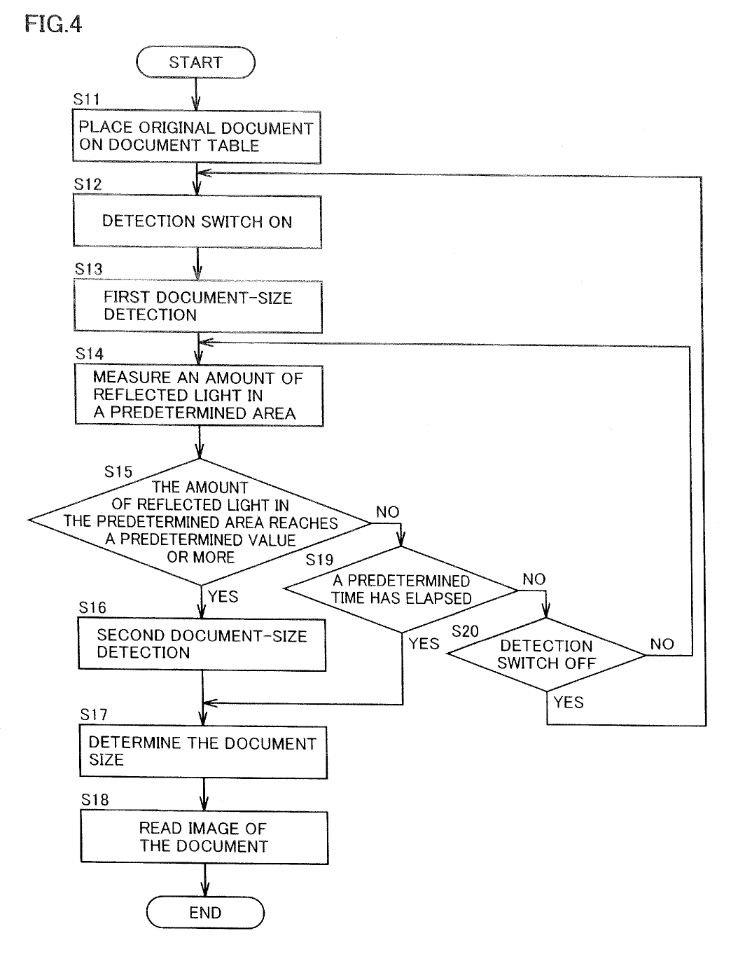

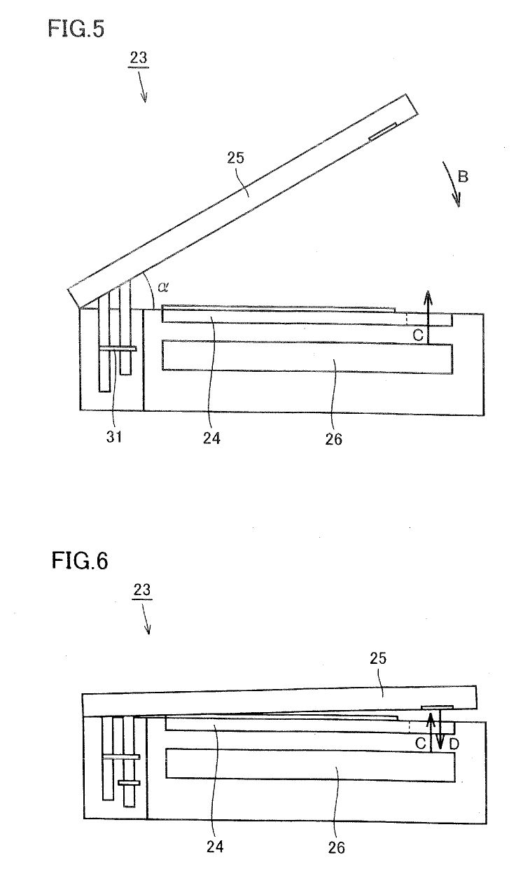

Next, a description will be made about a method for detecting the size of document P placed on the document table 24 by the image reading device 23. FIG. 4 is a flow chart showing operations of the controller 11 in this method. FIG. 5 illustrates the state where the document retainer 25 is closed at a predetermined angle α, which corresponds to FIG. 3. FIG. 6 illustrates the state where the document retainer 25 is completely closed, which corresponds to FIG. 3. In short, the document retainer 25 is shifted from the state shown in FIG. 3 to the state shown in FIG. 5 and closed.

Referring to FIGS. 1 to 4, the document P is first placed on the area enclosed by the dotted line on the document table 24 (step S11 in FIG. 4, hereinafter “step” is omitted), and then the document retainer 25 is closed further in the direction of arrow B.

The document retainer 25 that is further closed forms angle α with the document table 24, which is the state shown in FIG. 5. Then the detection switch 31 detects that the document retainer 25 has been closed at the predetermined angle α, thereby turning on the detection switch 31 (S12). In this manner, the document retainer 25 is detected to be at the predetermined angle α.

Upon turning on the detection switch 31, the first document-size detection is performed (S13). The document-size detection is performed by activating the above-described document-size detection unit.

After the completion of the first document-size detection, the document retainer 25 is closed further in the direction of arrow B. Then, the optical unit 26 measures the amount of reflected light in the area 34 (S14). Specifically, the optical unit 26 irradiates light upward from below the document table 24 and measures the reflected light. The optical unit 26 and controller 11 now operate as a reflected-light amount measurement unit. This reflected-light amount measurement unit conducts the measurement process on a regular basis, for example every 100 ms (millisecond), after the detection switch 31 is turned on until the expiration of a predetermined time interval.

Next, it is determined whether the measured amount of the reflected light reaches a predetermined value or more (S15). Then, the document retainer 25 is closed further as shown in FIG. 6. As the document retainer 25 enters a completely closed state, the white portion 33 reflects light in the direction of arrow D, thereby allowing the reflected light in the area 34 to reach the predetermined value or more. If the amount of reflected light has reached the predetermined value or more (YES in S15), the second document-size detection is performed (S16). As with the first document-size detection, the second document-size detection is performed by activating the above-described document-size detection unit. The controller 11 and so on now operate as a control unit as in the case of the above-described first document-size detection.

Subsequently, the size of the original document is determined based on the document sizes obtained through the first and second detections (S17). The controller 11 now operates as a document-size determination unit. At last, image data of the document P is read out according to the determined document size (S18). Reading of the image data is conducted by activating the above-described image reading unit.

The multifunctional device 10 forms an image in the above-described manner based on thus read image data.

According to the structure, when the amount of the reflected light in the area 34 reaches the predetermined value or more, the document retainer 25 is recognized to be completely closed and then the second document-size detection is initiated. Therefore, there is no need to provide a switch for detecting the completely closed document retainer 25 to initiate the second document-size detection process. In addition, this double detection of document size allows accurate detection of the document size. As a result, the size of the original document can be detected with a low-cost configuration.

Furthermore, the multifunctional device 10 including such an image reading device 23 can also accurately detect the size of original documents. Accordingly, the multifunctional device 10 allows the above-described image forming section 16 and so on to readily form images according to the document size.

Returning to S15, when the amount of the reflected light is less than the predetermined value (NO in S15), it is determined whether a predetermined time has elapsed (S19). If the predetermined time has elapsed (YES in S19), the size of the original document is determined from the size detected in the first detection. This may correspond to the following case. For example, when a thick book is opened and placed on the document table 24, the document retainer 25 cannot be completely closed and the amount of the reflected light in the area 34 cannot reach the predetermined value or more even after a predetermined time has elapsed. However, the above-described operation can determine the size of the original document through document-size detection even if the document retainer 25 cannot be completely closed.

On the other hand, if the predetermined time has not elapsed (NO in S19), it is determined whether the detection switch 31 is on (S20). In the case where the detection switch 31 is off (YES in S20), it is determined that the document retainer 25 is in an open state, and therefore the operation returns to S12 again to wait for the detection switch 31 to be turned on and then the first document-size detection is performed. If the detection switch 31 is still on (NO in S20), the operation returns to S14 again to measure the amount of the reflected light in the area 34 and determine whether the amount reaches the predetermined value or more.

In the above-described embodiment, an amount of the light reflected off the white portion 33 in the state where the document retainer 25 is completely closed is set as the predetermined value and the second document-size detection is set to be performed when the amount of the reflected light reaches the predetermined value or more. However, the present invention is not limited to this, and the predetermined value can be an amount of the reflected light when the document retainer 25 is not completely but almost closed.

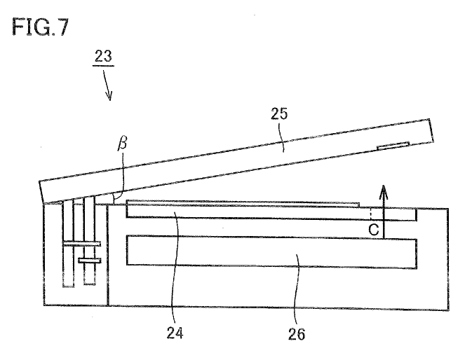

FIG. 7 illustrates the document retainer 25 in an almost completely closed state, which corresponds to FIG. 3. As shown in FIG. 7, the size of an original document is detected when the document retainer 25 and document table 24 form angle β, which is quite smaller than angle α, in other words, the document retainer 25 is almost completely closed. Specifically, an amount of light reflected off the white portion 33 when the document retainer 25 and document table 24 form angle β is set as a predetermined value.

According to the structure, the second document-size detection can be performed with the document retainer 25 not completely closed. In other words, the second document-size detection can be performed before the document retainer 25 is completely closed. This can expedite the determination of document size, thereby, for example, further shortening the first print out time.

Although the white portion 33 is provided at a part of the document-holding surface 32 so as to face an area on which original documents are not placed, the present invention is not limited to this, and the white portion 33 can be provided on the entire document-holding surface 32. This enables the reflected-light amount measurement unit to accurately measure the amount of the reflected light even if the reflected-light amount measurement unit deviates from the measurement position more or less, thereby determining whether the amount of the reflected light reaches the predetermined value or more.

Although one optical unit is used to read images of original documents and detect the size of the documents in the above embodiment, the present invention is not limited to this, and another optical unit can be provided to detect the document size in addition to an optical unit for reading the image of the document. Although the optical unit is designed to read images of documents and to detect the document size as moving in the sub-scan direction, the present invention is not limited to this, and the document-size detection can be performed by a plurality of optical units aligned at appropriate positions below the document table.

Although the detection switch is comprised of the PI sensor attached on the supporting portion and the protruding portion attached on the moving portion to detect the document retainer being at a predetermined position in the above embodiment, the present invention is not limited to this, and the detection switch to detect the document retainer being at the predetermined position can be comprised of other elements.

In the above embodiment, the document retainer in the image reading device can be replaced with a document retainer movable in the vertical direction.

The foregoing has described the embodiment of the present invention by referring to the drawings. However the invention should not be limited to the illustrated embodiment. It should be appreciated that various modifications and changes can be made to the illustrated embodiment within the scope of the appended claims and their equivalents.

What is claimed is:

1. An image reading device comprising:
a document table on which an original document is placed;
an openable and closable document retainer for retaining the original document on said document table, said document retainer having a white portion on a surface for holding the original document;
a detection switch for detecting that said document retainer is in a predetermined position;
a document-size detection unit for detecting the size of the original document on said document table;
a reflected-light amount measurement unit placed below an area on which the original document is not placed and which faces said white portion when said document retainer is closed, said reflected-light amount measurement unit irradiating light upwardly from below said document table and measuring the amount of the reflected light;
a control unit for controlling said document-size detection unit to perform the first document-size detection when said document retainer is detected to be in a predetermined position and to perform the second document-size detection when the amount of the reflected light measured by said reflected-light amount measurement unit reaches a predetermined value or more after the first document-size detection; and
a document-size determination unit for determining the size of the original document on said document table from the sizes of the original document obtained by the first and second detections performed by said document-size detection unit.

2. The image reading device according to claim 1, wherein
said white portion is provided on the entire surface for holding said original document.

3. The image reading device according to claim 1, wherein
said document-size determination unit determines the size of the original document from the original-document size detected through the first detection after a predetermined time period even if the amount of the reflected light measured by said reflected-light amount measurement unit is less than the predetermined value.

4. The image reading device according to claim 1, wherein
said control unit controls said document-size detection unit to perform said second document-size detection even if said document retainer is not completely closed after said first document-size detection.

5. An image forming apparatus comprises the image reading device according to claim 1.
